(19) United States
(12) Patent Application Publication
(10) Pub. No.: US 2002/0141009 A1
(43) Pub. Date: Oct. 3, 2002

(54) Performance monitoring for multi-port optical devices and systems

(76) Inventors: Jin Yu, San Diego, CA (US); Hongxing Dai, San Diego, CA (US); Jin-Yi Pan, San Diego, CA (US)

Correspondence Address: BROBECK, PHLEGER & HARRISON LLP, 12390 EL CAMINO REAL, SAN DIEGO, CA, 92130, US

(21) Appl. No.: 09/820,572

(22) Filed: Mar. 28, 2001

(51) Int. Cl. H04B 10/08; H04J 14/02

(52) U.S. Cl. 359/110; 359/128

(57) ABSTRACT

A performance monitoring system for an all-optical network utilizes a multi-port optical switch and measuring instruments, such as an optical spectrum analyzer and a combination of a tunable optical filter and a quality factor calculator, to provide various signal quality parameters for each optical channel in the network. Quality factor calculations for the optical channels are based upon probability density distribution parameters. Performance monitoring is conducted for an all-optical network during normal operations without having to disconnect any of the optical components from the network.

### BACKGROUND OF THE INVENTION

1. Field of the Invention

The present invention relates to optical systems, and more particularly, to performance monitoring for optical systems.

2. Background Art

As optical switching technology advances, optical fiber communications networks are increasingly relying on all-optical switching systems for the routing of multiple optical channels between different sources and destinations. With steadily increasing demands of high-speed service on the internet, it is becoming necessary for telecommunications carriers to multiplex, demultiplex and switch optical paths dynamically in an optical network or between different optical networks. In general, an all-optical switching system is typically independent of the bit rate and the protocol of data transmission, thereby providing advantages of bit-rate and protocol transparency over a conventional electro-optical switching system with electronic processing, which would require optical-to-electronic and electronic-to-optical signal conversions.

Because of the advantages of bit-rate and protocol transparency, an all-optical switching system is capable of offering a high degree of scalability with reusable resources, thereby resulting in better network economy for broadband networking. Compared to a conventional electro-optical switching system which requires optical-to-electronic and electronic-to-optical signal conversions and is usually limited to a data rate of no greater than 10 Gbps, an all-optical switching system is typically capable of handling multiple wavelength-multiplexed optical channels with very wide overall optical bandwidths, thereby allowing the optical networks to achieve a very high rate of data throughput.

As a tradeoff, however, performance monitoring of optical transmissions in wideband optical fiber communications networks which utilize all-optical switching systems is not as straightforward as in conventional electro-optical switching systems with electronic signal processing. In a conventional electro-optical switching system with electronic signal processing, conventional schemes of synchronous optical network (SONET) performance monitoring have been widely used.

To ensure the proper functioning of optical fiber communications networks which implement all-optical switching systems, performance monitoring of optical transmissions is needed as a long-term process against degradation of performance of optical components. Furthermore, because all-optical switching systems may be scalable, another purpose of performance monitoring is to provide a system diagnosis during the process of network state transition due to various types of changes in the network configuration such as changes due to optical channel add-drop multiplexing, channel switching, or in-service upgrades.

Therefore, there is a need for a system and a method which allow performance monitoring of various parameters of all-optical communications networks to be achieved efficiently and cost effectively, to protect all-optical networks against degradation of component performance and to provide defect diagnosis during network state transitions.

### SUMMARY OF THE INVENTION

The present invention provides a performance monitoring system, generally comprising:

a plurality of input optical paths;

a plurality of output optical paths;

an optical switch having a first plurality of inputs, a second plurality of inputs and a plurality of outputs, the first plurality of inputs of the optical switch connected it to the input optical paths, the second plurality of inputs of the optical switch connected to the output optical paths; and

at least one measuring instrument connected to at least one of the outputs of the optical switch.

Furthermore, the present invention provides a method of monitoring the performance of an optical device or system having a plurality of optical paths each capable of carrying optical signals in a plurality of wavelength channels, the method generally comprising the steps of:

selecting one of the optical paths for performance monitoring;

switching optical signals carried by the selected optical path to at least one measuring instrument;

obtaining probability density distribution parameters of the optical signals for a given one of the wavelength channels of the selected optical path; and

computing a quality factor for the given wavelength channel of the selected optical path based upon the probability density distribution parameters.

Advantageously, the system and method according to embodiments of the present invention are capable of providing performance monitoring of all-optical networks efficiently and cost effectively, to protect the networks from failure or degradation of performance. For example, the system and method according to embodiments of the present invention are capable of providing measured parameters which may generate alerts if a degradation of component performance is detected.

As another example, the performance monitoring system and method according to embodiments of the present invention may serve to diagnose defects during the process of network state transitions of an all-optical switching system due to changes in network configuration such as channel add-drop multiplexing, channel switching and in-service upgrade.

As yet another example, the performance monitoring system and method according to embodiments of the present invention are capable of providing measured parameters for dynamic channel power equalization for optical systems, to obviate problems such as non-uniformity of insertion loss of optical cross-connect systems when optical paths change dynamically, as well as non-uniformity of transmitted power and instability of wavelengths of laser sources.

### BRIEF DESCRIPTION OF THE DRAWINGS

The present invention will be described with particular embodiments thereof, and references will be made to the drawings in which:

FIG. 1 shows a diagram of an embodiment of the performance monitoring system according to the present invention; and

FIG. 2 shows a flow chart illustrating an embodiment of a method of performance monitoring according to the present invention.

### DETAILED DESCRIPTION

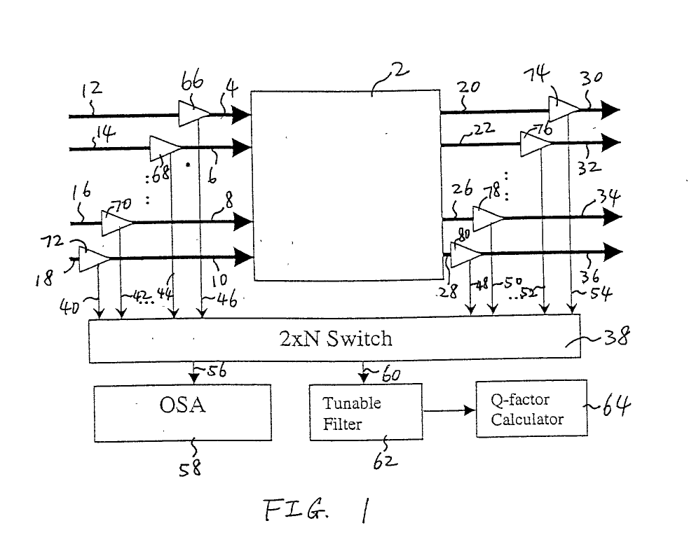

FIG. 1 shows a diagram of an embodiment of the performance monitoring system according to the present invention. A multi-port optical device or system 2 has a plurality of optical inputs 4, 6, 8 and 10 connected to a plurality of input optical paths 12, 14, 16 and 18, respectively, and a plurality of optical outputs 20, 22, 26 and 28 connected to a plurality of output optical paths 30, 32, 34 and 36, respectively. The performance monitoring system according to the present invention is generally applicable to the performance monitoring of various types of optical devices with multiple inputs or outputs with multiple optical channels, although specific embodiments will be described with reference to an optical cross-connect fabric in a dense wavelength division multiplexing (DWDM) network. Examples of devices or systems to be monitored include an optical wavelength switching system with optical multiplexers, demultiplexers and optical switching arrays, optical add-drop multiplexers, and optical switching fabrics with active components such as laser amplifiers. In a typical DWDM network, any one of the input or output optical paths may carry a single wavelength channel or a plurality of wavelength-multiplexed channels.

In FIG. 1, an optical switch 38 is provided in the performance monitoring system. In an embodiment, the optical switch 38 has a first plurality of inputs 40, 42, 44 and 46 connected to the input optical paths 18, 16, 14 and 12, respectively. Furthermore, the optical switch 38 has a second plurality of inputs 48, 50, 52 and 54 connected to the output optical paths 28, 26, 22 and 20, respectively. The outputs of the optical switch 38 include a first output 56 connected to an optical spectrum analyzer 58 and a second output 60 connected to a tunable optical filter 62. The tunable filter 62 is capable of sweeping a range of wavelengths covering all wavelength-multiplexed optical channels on any given one of the input and output optical paths 12, 14, 16, 18, 20, 22, 26 and 28. In an embodiment, a quality factor calculator 64 is connected to the tunable filter 62 to compute the quality factor Q for each of the optical channels on any one of the input or output optical paths selected for monitoring.

In an embodiment, a plurality of optical amplifiers 66, 68, 70 and 72 are provided along the input optical paths 12, 14, 16 and 18, respectively. Each of the optical amplifiers 66, 68, 70 and 72 is connected to a respective input of the multi-port device or system 2 and to a respective input of the optical switch 38. The optical signals carried along the input optical paths 12, 14, 16 and 18 are thus amplified before they are received by the optical device or system 2 which is subject to monitoring. The input optical signals are tapped from the respective optical amplifiers 72, 70, 68 and 66 to the first plurality of inputs 40, 42, 44 and 46 of the optical switch 38 for measurement and analysis by the optical spectrum analyzer 58 or the quality factor calculator 64.

The output optical signals from the multi-port device or system 2 can also be monitored by the performance monitoring system. In an embodiment, a plurality of additional optical amplifiers 74, 76, 78 and 80 are provided along the output optical paths 20, 22, 26 and 28, respectively, to amplify the output optical signals from the multi-port device or system 2 which is subject to monitoring. Each of the optical amplifiers 74, 76, 78 and 80 is connected to a respective output of the multi-port device or system 2 and a respective input of the optical switch 38. The output optical signals are tapped from the optical amplifiers 74, 76, 78 and 80 to the second plurality of inputs 54, 52, 50 and 48 of the optical switch 38, respectively, to allow the output signals to be measured and processed by the optical spectrum analyzer 58 or the quality factor calculator 64.

If the system 2 being monitored is a typical all-optical cross-connect fabric, the number of output optical paths and the number of input optical paths are usually the same, but each pair of input and output optical paths may carry different wavelength-multiplexed optical channels because of the switching operations of the optical cross-connect fabric. The number of input and output optical paths may not be identical in a different embodiment. The optical switch 38 as shown in FIG. 1 is a 2×N switch with N inputs and two outputs. The optical switch for the performance monitoring operations may have a different array size if additional outputs need be provided to convey the optical signals to additional measuring instruments. The performance monitoring system according to the present invention may be implemented as either a laboratory setup or an embedded system in an operational optical network. During normal operations, no optical fiber or component need be disconnected from the optical network in order to measure the signal quality parameters of any of the optical channels, thereby allowing for uninterrupted operations of the network while its performance is being monitored either continuously or periodically.

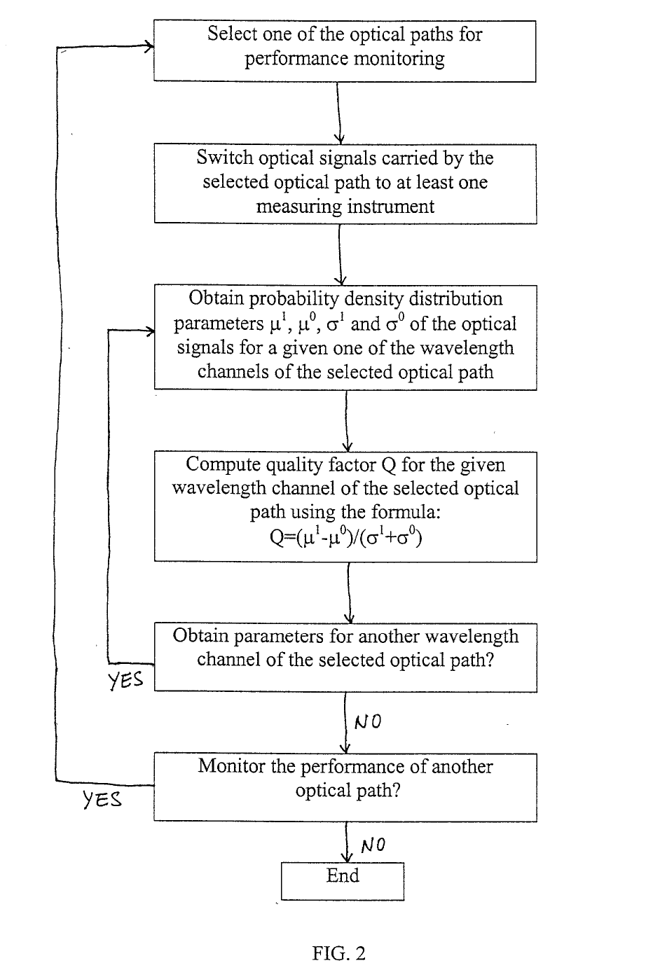

FIG. 2 is a flow chart illustrating an embodiment of a method of performance monitoring for an all-optical network in an embodiment according to the present invention. As described above, each of the input and output optical paths to which the optical device or system is connected is capable of carrying optical signals in a plurality of wavelength division multiplexed optical channels. Any one of the optical paths, which may be either an input optical path or an output optical path, can be selected for performance monitoring at a given time. The optical signals carried by the optical path selected for performance monitoring is switched by an optical switch, such as the 2×N optical switch 38 as shown in FIG. 1, to at least one measuring instrument, which may be the optical spectrum analyzer 58 or the combination of the tunable filter 62 and the quality factor calculator 64 as shown in FIG. 1. Other types of measuring instruments may also be implemented for performance monitoring of an optical network within the scope of the present invention.

In an embodiment in which optical signals in a given wavelength channel of the selected optical path are binary digital signals in the form of a bit stream of 1's and 0's, probability density distribution parameters can be obtained from the measurements to compute the quality factor for the given wavelength channel of the selected optical path. For optical signals in the form of a binary bit stream, the relevant probability density distribution parameters for computing the quality factor Q include a mean μ¹ at bit level “1”, a mean μ⁰ at bit level “0”, a standard deviation σ¹ at bit level “1”, and a standard deviation σ⁰ at bit level “0”. The quality factor Q is computed from the probability density distribution parameters for the given wavelength channel of the selected optical path according to the following relationship:

Q=(μ¹−μ⁰)/(σ¹+σ⁰)

The measurements of the probability density distribution parameters and the computation of the quality factor Q can be repeated for other wavelength channels of the selected optical path. In an embodiment, a sweep is made by the measuring instrument over a range of wavelengths covering all of the wavelength division multiplexed optical channels on the selected optical path. For example, the passband of the tunable optical filter 62 in FIG. 1 can be tuned to select one wavelength channel at a time on the optical path selected for monitoring.

After the quality factor calculation for the given wavelength channel is completed, the tunable optical filter 62 may sweep through successive wavelength channels to allow the quality factor calculator 64 to compute quality factors for all of the wavelength channels on the selected optical path. In a typical DWDM optical network, the number of wavelength division multiplexed optical channels and the channel wavelengths are usually predetermined, for example, according to a standard International Telecommunications Union (ITU) spectral grid. The tunable optical filter 62 may be programmed to sweep through all of the wavelength channels or select only some of the wavelength channels on a given optical path for performance monitoring.

After the performance parameters for the desired wavelength channels on one of the optical paths are obtained and analyzed, performance monitoring for another optical path can be performed by repeating the steps as shown in FIG. 2 and described above. In an embodiment in which the performance monitoring system of FIG. 1 is implemented, the optical signals carried along a given optical path, which can be any one of the input optical paths or the output optical paths selected for monitoring, are switched by the optical switch 38 either to the second switch output 60 for quality factor calculations, or to the first switch output 56, which is connected to the optical spectrum analyzer 58 for various functions such as detecting channel presence and measuring channel power, optical signal-to-noise ratio and channel wavelength.

A conventional optical spectrum analyzer is typically capable of sweeping a certain wavelength range in a sufficient resolution bandwidth and detecting or recording the intensity at each sampled wavelength point. The optical intensity at each sampled wavelength point may be recorded by a photodetector which is typically provided in the conventional optical spectrum analyzer, and optical intensity distribution within the wavelength range is subsequently obtained. The characteristics of the optical channels such as channel presence, channel power, optical signal-to-noise ratio and channel wavelength are captured and reported by analyzing the optical intensity distribution within the wavelength range by the optical spectrum analyzer.

The ability of an optical spectrum analyzer to detect and analyze optical signals is usually determined by the accuracy of wavelength and optical intensity measurements, the resolution bandwidth, the wavelength range, the dynamic range, the sweeping speed, the repeatability of measurements and other factors. Based on currently available technology, channel power and wavelength can be measured with satisfactory accuracy by a conventional optical spectrum analyzer. However, there is typically a limitation on the optical signal-to-noise ratio measurements because of saturation above a certain intensity level. The saturation level can be usually managed to meet the monitoring requirements of up to 10 Gbps in a 50 GHz channel spacing with existing optical spectrum analyzer technology.

Furthermore, some of the signal degradation factors including signal distortion, cross-talk and timing jitter, which adversely affect the overall signal quality, are not readily obtained by a conventional optical spectrum analyzer using existing technology. Despite these limitations, however, a conventional optical spectrum analyzer is capable of providing relatively fast and sufficiently informative performance monitoring for an all-optical switching network.

Compared to measurements by a conventional optical spectrum analyzer, the quality factor calculation provided by the combination of the tunable optical filter and the quality factor calculator is a more accurate indication of the overall signal quality of each optical channel. As described above, the tunable optical filter passes optical signals of one optical channel at a time to the quality factor calculator, which derives the quality factor from an analysis of the probably density distribution parameters at bit levels “1” and “0” from the bit stream. The means and the standard deviations at bit levels “1” and “0” are obtained by performing a statistical analysis of the measured intensity levels of the optical signals at bit levels “1” and “0”.

Various factors of signal degradation such as signal distortion, cross-talk and timing jitter, which are not readily obtained from measurements by a conventional optical spectrum analyzer, contribute to the value of the quality factor. By computing the quality factor based upon the relevant probability density distribution parameters at bit levels “1” and “0”, an accurate representation of signal quality for the given wavelength channel is obtained without having to measure the degradation factors such as signal distortion, cross-talk and timing jitter directly. Furthermore, a computed value of the quality factor can be converted to a bit error rate, which is a basic parameter of a digital communications system, for digital performance monitoring in various applications.

The bit error rate is typically related to the error function (erf) of a certain function of bit energy and noise power spectrum. Because the quality factor is dependent upon the probability density distribution parameters, the bit error rate (BER) can be derived from the quality factor according to the following relationship:

BER=0.5*erf(Q/1.414)

At least theoretically, the evaluation of quality factors for optical channels of different signal qualities take roughly the same amount of time no matter how low the bit error rates are. The quality factor computation has the advantage of reporting extremely low bit error rates over conventional synchronous optical network (SONET)-based digital performance monitoring, because conventional SONET performance monitoring is based upon direct counting of bit errors. The quality factor evaluation described above is a real-time approach and does not need history to predict the bit error rate. Because of this advantage, the method of optical performance monitoring according to embodiments of the present invention is capable of providing bit error rate evaluations at much lower cost than conventional SONET-based digital performance monitoring.

The implementation described above with reference to FIG. 1 includes a 2×N optical switch with two outputs, one of which is connected to an optical spectrum analyzer and the other one of which is connected to the combination of a tunable optical filter and a quality factor calculator. For each of the input and output optical paths, the optical signals are tapped out to the respective input of the 2×N optical switch after being amplified by the optical amplifier disposed along the respective optical path. The optical switch is implemented to pick up wavelength division multiplexed optical signals on at least one of the optical paths and convey the signals to the optical spectrum analyzer or the combination of the tunable optical filter and the quality factor calculator. With a 2×N optical switch, optical signals propagating along two of the optical paths may be tapped out to two measuring instruments simultaneously.

The optical spectrum analyzer can perform coarse measurements quickly such that channel presence, channel optical power, optical signal-to-noise ratio and channel wavelength can be determined for all of the optical channels on any of the input and output optical paths. Spectral analysis can be executed periodically by the optical spectrum analyzer for each of the input and output optical paths. This type of spectral analysis is suitable for measuring the performance of a typical optical cross-connect fabric which includes optical multiplexer and demultiplexer components and optical switch arrays for DWDM applications, as well as other types of multi-port optical devices or systems.

In the embodiment shown in FIG. 1, the quality factor calculator is capable of deriving the quality factor based upon the measured probability density distribution parameters for one wavelength channel selected by the tunable passband of the tunable optical filter at a time. Compared to the measurements by the optical spectrum analyzer, the quality factor evaluation typically takes a much longer time for all of the wavelength channels on all of the input and output optical paths. Nevertheless, the quality factor evaluation gives a more accurate representation of the signal quality of each wavelength channel on each of the optical paths.

As apparent from FIG. 1, the performance monitoring system can be made scalable if the optical switch 38 has more inputs than the number of existing input and output optical paths, such that additional optical paths may be connected to the optical switch for performance monitoring by the measuring instruments. Furthermore, the optical switch may have additional outputs which are capable of routing the optical signals to additional measuring instruments. For example, the additional outputs of the optical switch may be connected to additional tunable optical filters to allow quality factor calculations to be performed simultaneously for optical channels on different optical paths. With multiple optical outputs, the optical switch allows performance monitoring to be achieved with the shared resources of the optical spectrum analyzer and the quality factor calculator, to provide various parameters representing the signal quality of each of the channels.

The performance monitoring system and method according to embodiments of the present invention can be implemented in various practical applications. For example, performance monitoring can be used in a proactive process against degradation of optical components in the system being monitored during normal operations. In this process, the satisfactory signal quality of each channel is first determined and the baseline for each of the parameters is set. The upper and lower allowable levels of the parameters are set as thresholds.

For example, the lower threshold level of the quality factor or the upper threshold level of the bit error rate may be set for each of the wavelength channels. A cross-threshold alert is generated if the allowable threshold level of any of the signal quality parameters is crossed. For example, a cross-threshold alert may be generated if the quality factor computed from the probability density distribution parameters for any given wavelength channel is less than the threshold level. During long-term system operation, a large degradation in component performance can trigger a cross-threshold alert, which in turn calls for an immediate requirement for system maintenance.

As another example, performance monitoring according to embodiments of the present invention may be implemented for defect diagnosis. A failure could result from incorrect human operation or system error during a network state transition such as an optical channel add-drop multiplexing operation, a channel switching operation or an in-service upgrade. By repeating the measurements for each of the wavelength channels and for each of the input and output optical paths, the failure point in an optical network can be traced and isolated in a short time.

Performance monitoring according to embodiments of the present invention is also applicable to system control operations. For example, optical power can be equalized dynamically over all of the optical channels based upon channel power monitoring. Dynamic channel power equalization is important for an all-optical cross-connect fabric because of non-uniformity of insertion loss of conventional optical switches in the fabric when light paths change dynamically. With an optical spectrum analyzer, the performance monitoring system is capable of determining whether optical power is balanced among all of the wavelength channels, and if the optical power is unbalanced, a system controller can equalize the optical power distribution among the wavelength channels.

As another example, the performance monitoring system is capable of providing measurements for locking the wavelengths of laser transmitters which may typically have a tendency of wavelength drifting. For example, a conventional semiconductor distributed feedback (DFB) laser device usually needs a wavelength locker to stabilize its transmitted wavelength. With dynamic wavelength channel monitoring according to embodiments of the present invention, a shared and centralized wavelength monitoring and locking mechanism can be provided to lock the wavelengths of semiconductor DFB laser devices.

The present invention has been described with respect to particular embodiments thereof, and numerous modifications can be made which are within the scope of the invention as set forth in the claims.

What is claimed is:

1. A performance monitoring system, comprising:
a plurality of input optical paths;
a plurality of output optical paths;
an optical switch having a first plurality of inputs, a second plurality of inputs and a plurality of outputs, the first plurality of inputs of the optical switch connected to the input optical paths, the second plurality of inputs of the optical switch connected to the output optical paths;
an optical filter connected to a first one of the outputs of the optical switch; and
a quality factor calculator connected to the optical filter.

2. The system of claim 1, further comprising an optical spectrum analyzer connected to a second one of the outputs of the optical switch.

3. The system of claim 1, wherein the optical filter comprises a tunable filter capable of sweeping a range of wavelengths covering optical channels on any one of the input and output optical paths.

4. The system of claim 1, further comprising an optical cross-connect fabric having a plurality of inputs connected to the input optical paths and a plurality of outputs connected to the output optical paths.

5. The system of claim 4, further comprising a plurality of optical amplifiers disposed along the input optical paths, each of the optical amplifiers connected to a respective one of the inputs of the optical cross-connect fabric and a respective one of the first plurality of inputs of the optical switch.

6. The system of claim 4, further comprising a plurality of optical amplifiers disposed along the output optical paths, each of optical amplifiers connected to a respective one of the outputs of the optical cross-connect fabric and a respective one of the second plurality of inputs of the optical switch.

7. The system of claim 1, wherein the optical switch comprises a 2×N optical switch having N inputs connected to the input and output optical paths and two outputs, one of which is connected to the optical filter.

8. A performance monitoring system, comprising:
a plurality of input optical paths;
a plurality of output optical paths;
an optical switch having a first plurality of inputs, a second plurality of inputs and a plurality of outputs, the first plurality of inputs of the optical switch connected to the input optical paths, the second plurality of inputs of the optical switch connected to the output optical paths; and
an optical spectrum analyzer connected to a first one of the outputs of the optical switch.

9. The system of claim 8, further comprising:
an optical filter connected to a second one of the outputs of the optical switch; and
a quality factor calculator connected to the optical filter.

10. The system of claim 9, wherein the optical filter comprises a tunable filter capable of sweeping a range of wavelengths covering optical channels on any one of the input and output optical paths.

11. The system of claim 8, further comprising an optical cross-connect fabric having a plurality of inputs connected to the input optical paths and a plurality of outputs connected to the output optical paths.

12. The system of claim 11, further comprising a plurality of optical amplifiers disposed along the input optical paths, each of the optical amplifiers connected to a respective one of the inputs of the optical cross-connect fabric and a respective one of the first plurality of inputs of the optical switch.

13. The system of claim 11, further comprising a plurality of optical amplifiers disposed along the output optical paths, each of optical amplifiers connected to a respective one of the outputs of the optical cross-connect fabric and a respective one of the second plurality of inputs of the optical switch.

14. The system of claim 8, wherein the optical switch comprises a 2×N optical switch having N inputs connected to the input and output optical paths and two outputs, one of which is connected to the optical spectrum analyzer.

15. A performance monitoring system, comprising:
a plurality of input optical paths each capable of carrying optical signals in multiple wavelength channels;
a plurality of output optical paths each capable of carrying optical signals in multiple wavelength channels;
an optical switch having a first plurality of inputs, a second plurality of inputs and a plurality of outputs, the first plurality of inputs of the optical switch connected to the input optical paths, the second plurality of inputs of the optical switch connected to the output optical paths;
an optical spectrum analyzer connected to a first one of the outputs of the optical switch;
a tunable optical filter connected to a second one of the outputs of the optical switch, the tunable optical filter capable of sweeping a range of wavelengths covering the multiple wavelength channels of the input and output optical paths; and
a quality factor calculator connected to the optical filter.

16. The system of claim 15, further comprising an optical cross-connect fabric having a plurality of inputs connected to the input optical paths and a plurality of outputs connected to the output optical paths.

17. The system of claim 16, further comprising a plurality of optical amplifiers disposed along the input optical paths, each of the optical amplifiers connected to a respective one of the inputs of the optical cross-connect fabric and a respective one of the first plurality of inputs of the optical switch.

18. The system of claim 16, further comprising a plurality of optical amplifiers disposed along the output optical paths, each of optical amplifiers connected to a respective one of the outputs of the optical cross-connect fabric and a respective one of the second plurality of inputs of the optical switch.

19. The system of claim 15, wherein the optical switch comprises a 2×N optical switch having N inputs connected to the input and output optical paths, and two outputs connected to the optical filter and the optical spectrum analyzer.

20. A method of monitoring performance of an optical device having a plurality of optical paths each capable of carrying optical signals in a plurality of wavelength channels, the method comprising the steps of:
(a) selecting one of the optical paths for performance monitoring;
(b) switching optical signals carried by the selected optical path to at least one measuring instrument;
(c) obtaining probability density distribution parameters of the optical signals for a given one of the wavelength channels of the selected optical path; and
(d) computing a quality factor for the given wavelength channel of the selected optical path based upon the probability density distribution parameters.

21. The method of claim 20, further comprising the step of repeating steps (a)-(d) to compute quality factors for all of the optical paths.

22. The method of claim 20, further comprising the step of sweeping a range of wavelengths covering the wavelength channels of the selected optical path.

23. The method of claim 22, further comprising the step of repeating steps (c)-(d) to compute quality factors for all of the wavelength channels of the selected optical path.

24. The method of claim 23, wherein the step of sweeping the range of wavelengths is performed by a tunable filter.

25. The method of claim 20, wherein the optical device has N optical paths, and wherein the step of switching the optical signals is performed by a 2×N optical switch having N inputs connected to the N optical paths, a first output connected an optical spectrum analyzer, and a second output connected to a tunable filter.

26. The method of claim 25, further comprising the step of measuring channel power and wavelength by the optical spectrum analyzer.

27. The method of claim 20, wherein the optical signals comprise binary digital signals, and wherein the probability density distribution parameters include a mean μ¹ at bit level “1”, a standard deviation σ¹ at bit level “1”, a mean μ⁰ at bit level “0”, and a standard deviation σ⁰ at bit level “0”.

28. The method of claim 27, wherein the step of computing the quality factor comprises the steps of:
subtracting μ⁰ from μ¹ to obtain a difference of means;
adding σ⁰ and σ¹ to obtain a sum of standard deviations; and
dividing the difference of means by the sum of standard deviations to obtain the quality factor.

29. The method of claim 20, further comprising the steps of:
setting a threshold level of quality factor for each of the wavelength channels; and
generating a cross-threshold alert if the quality factor computed from the probability density distribution parameters for the wavelength channel is less than the threshold level.

30. The method of claim 20, further comprising the step of deriving signal quality parameters for each of the wavelength channels based upon the quality factor.

31. The method of claim 30, wherein the signal quality parameters include a bit error rate.

32. The method of claim 20, further comprising the step of repeating steps (a)-(d) during a network state transition.

33. The method of claim 20, further comprising the steps of:
determining whether optical power is balanced among the wavelength channels; and
equalizing the optical power among the wavelength channels in response to the step of determining that the optical power is unbalanced.

34. A method of monitoring performance of an optical device having a plurality of optical paths each capable of carrying optical signals in a plurality of wavelength channels, the method comprising the steps of:
(a) selecting one of the optical paths for performance monitoring;
(b) switching optical signals carried by the selected optical path to at least one measuring instrument;
(c) sweeping a range of wavelengths covering the wavelength channels of the selected optical path;
(d) obtaining probability density distribution parameters of the optical signals for each of the wavelength channels of the selected optical path; and
(e) computing a quality factor for each of the wavelength channels of the selected optical path based upon the probability density distribution parameters.

35. The method of claim 34, further comprising the step of repeating steps (a)-(e) to compute quality factors for all of the optical paths.

36. The method of claim 34, wherein the step of sweeping the range of wavelengths is performed by a tunable filter.

37. The method of claim 34, wherein the optical device has N optical paths, and wherein the step of switching the optical signals is performed by a 2×N optical switch having N inputs connected to the N optical paths, a first output connected an optical spectrum analyzer, and a second output connected to a tunable filter.

38. The method of claim 37, further comprising the step of measuring channel power and wavelength by the optical spectrum analyzer.

39. The method of claim 34, wherein the optical signals comprise binary digital signals, and wherein the probability density distribution parameters include a mean μ¹ at bit level “1”, a standard deviation σ¹ at bit level “1”, a mean μ⁰ at bit level “0”, and a standard deviation σ⁰ at bit level “0”.

40. The method of claim 39, wherein the step of computing the quality factor comprises the steps of:
subtracting μ⁰ from μ¹ to obtain a difference of means; adding σ⁰ and σ¹ to obtain a sum of standard deviations; and
dividing the difference of means by the sum of standard deviations to obtain the quality factor.

41. The method of claim 34, further comprising the steps of:
setting a threshold level of quality factor for each of the wavelength channels; and
generating a cross-threshold alert if the quality factor computed from the probability density distribution parameters for the wavelength channel is less than the threshold level.

42. The method of claim 34, further comprising the step of deriving signal quality parameters for each of the wavelength channels based upon the quality factor.

43. The method of claim 42, wherein the signal quality parameters include a bit error rate.

44. The method of claim 34, further comprising the step of repeating steps (a)-(d) during a network state transition.

45. The method of claim 34, further comprising the steps of:
determining whether optical power is balanced among the wavelength channels; and
equalizing the optical power among the wavelength channels in response to the step of determining that the optical power is unbalanced.

46. A method of monitoring performance of an optical device having a plurality of optical paths each capable of carrying optical signals in a plurality of wavelength channels, the method comprising the steps of:
(a) selecting one of the optical paths for performance monitoring;
(b) switching optical signals carried by the selected optical path to at least one measuring instrument;
(c) obtaining probability density distribution parameters of the optical signals for a given one of the wavelength channels of the selected optical path, the probability density distribution parameters including a mean μ¹ at bit level “1”, a standard deviation σ¹ at bit level “1”, a mean μ⁰ at bit level “0”, and a standard deviation σ⁰ at bit level “0”; and
(d) computing a quality factor for the given wavelength channel of the selected optical path, comprising the steps of:
subtracting μ⁰ from μ¹ to obtain a difference of means;
adding σ⁰ and σ¹ to obtain a sum of standard deviations; and
dividing the difference of means by the sum of standard deviations to obtain the quality factor.

47. The method of claim 46, further comprising the step of repeating steps (a)-(d) to compute quality factors for all of the optical paths.

48. The method of claim 46, further comprising the step of sweeping a range of wavelengths covering the wavelength channels of the selected optical path.

49. The method of claim 48, further comprising the step of repeating steps (c)-(d) to compute quality factors for all of the wavelength channels of the selected optical path.

50. The method of claim 49, wherein the step of sweeping the range of wavelengths is performed by a tunable filter.

51. The method of claim 46, wherein the optical device has N optical paths, and wherein the step of switching the optical signals is performed by a 2×N optical switch having N inputs connected to the N optical paths, a first output connected an optical spectrum analyzer, and a second output connected to a tunable filter.

52. The method of claim 51, further comprising the step of measuring channel power and wavelength by the optical spectrum analyzer.

53. The method of claim 46, further comprising the steps of:
setting a threshold level of quality factor for each of the wavelength channels; and
generating a cross-threshold alert if the quality factor computed from the probability density distribution parameters for the wavelength channel is less than the threshold level.

54. The method of claim 46, further comprising the step of deriving signal quality parameters for each of the wavelength channels based upon the quality factor.

55. The method of claim 54, wherein the signal quality parameters include a bit error rate.

56. The method of claim 46, further comprising the step of repeating steps (a)-(d) during a network state transition.

57. The method of claim 46, further comprising the steps of:
determining whether optical power is balanced among the wavelength channels; and
equalizing the optical power among the wavelength channels in response to the step of determining that the optical power is unbalanced.

58. A method of monitoring performance of an optical device having a plurality of optical paths each capable of carrying optical signals in a plurality of wavelength channels, the method comprising the steps of:
(a) selecting one of the optical paths for performance monitoring;
(b) switching optical signals carried by the selected optical path to at least one measuring instrument;
(c) measuring optical power, wavelength and signal-to-noise ratio for all of the wavelength channels of the selected optical path;
(d) obtaining probability density distribution parameters of the optical signals for a given one of the wavelength channels of the selected optical path; and
(e) computing a quality factor for the given wavelength channel of the selected optical path based upon the probability density-distribution parameters.

59. The method of claim 58, further comprising the step of sweeping a range of wavelengths covering the wavelength channels of the selected optical path.

60. The method of claim 59, further comprising the step of repeating steps (d)-(e) to compute quality factors for all of the wavelength channels of the selected optical path.

61. The method of claim 60, wherein the step of sweeping the range of wavelengths is performed by a tunable filter, and wherein the step of computing the quality factors is performed by a quality factor calculator.

62. The method of claim 58, wherein the step of measuring the optical power, wavelength and signal-to-noise ratio for all of the wavelength channels is performed by an optical spectrum analyzer.

63. The method of claim 58, wherein the optical signals comprise binary digital signals, and wherein the probability density distribution parameters include a mean μ¹ at bit level “1”, a standard deviation σ¹ at bit level “1”, a mean μ⁰ at bit level “0”, and a standard deviation σ⁰ at bit level “0”.

64. The method of claim 63, wherein the step of computing the quality factor comprises the steps of:
subtracting μ⁰ from μ¹ to obtain a difference of means;
adding σ⁰ and σ¹ to obtain a sum of standard deviations; and
dividing the difference of means by the sum of standard deviations to obtain the quality factor.

65. The method of claim 64, further comprising the step of deriving a bit error rate from the quality factor.

66. The method of claim 58, further comprising the steps of:
determining whether optical power is balanced among the wavelength channels; and
equalizing the optical power among the wavelength channels in response to the step of determining that the optical power is unbalanced.
